(19) United States
(12) Patent Application Publication
(10) Pub. No.: US 2015/0329270 A1
(43) Pub. Date: Nov. 19, 2015

(54) INSULATOR APPARATUS FOR A BEVERAGE CONTAINER

(71) Applicant: Yeh-Fei CHU, Taichung City (TW)

(72) Inventor: Yeh-Fei CHU, Taichung City (TW)

(21) Appl. No.: 14/281,571

(22) Filed: May 19, 2014

(51) Int. Cl. B65D 81/38; F16F 1/10; A47G 23/02

(52) U.S. Cl. CPC B65D 81/3886; A47G 23/0216; F16F 1/10; A47G 2023/0291; F16F 2230/0005

(57) ABSTRACT

An insulator apparatus includes a deformable insulator body made of a foam material, a self-coiling spring strip secured to the deformable insulator body, and a deformable decorative sheet disposed on the deformable insulator body. The deformable decorative sheet has a base layer that is made of a material of paper or plastics, and a pattern layer disposed on the base layer. A coiling action of the self-coiling spring strip results in conversion of the insulator apparatus from a straight state to a bent state. At the bent state, the deformable decorative sheet completely covers the deformable insulator body and the self-coiling spring strip.

### BACKGROUND OF THE INVENTION

1. Field of the Invention

This invention relates to an insulator apparatus, more particularly to an insulator apparatus adapted to encircle a beverage container.

2. Description of the Related Art

U.S. Pat. No. 5,845,804 discloses a conventional insulator apparatus that includes an insulator body made of foam material, and two self-coiling spring strips embedded in the foam material. Coiling action of the self-coiling spring strips urges the insulator body to convert from a straight state to a bent state. At the bent state, the insulator apparatus encircles an outer surface of a beverage container to maintain the temperature of drink inside the beverage container. However, the exposed insulator body may adversely affect aesthetic appearance of the beverage container.

Another conventional insulator apparatus includes a fabric layer that is disposed over an insulator body made of a foam material and that is printed with a pattern. The fabric layer covers the insulator body and thus could improve aesthetic properties of the insulator apparatus. However, a complicated and exquisite pattern would not be accurately and precisely formed on the fabric layer.

### SUMMARY OF THE INVENTION

Therefore, the object of the present invention is to provide an insulator apparatus for a beverage container that can overcome the aforesaid drawbacks of the prior art.

According to this invention, an insulator apparatus is adapted to encircle a beverage container, and includes a deformable insulator body, a self-coiling spring strip, and a deformable decorative sheet. The deformable insulator body is made of a foam material, and has a first surface adapted to contact an outer surface of the beverage container, and a second surface opposite to the first surface. The self-coiling spring strip is secured to the deformable insulator body. The deformable decorative sheet is disposed on the second surface of the deformable insulator body, and has a base layer made of a material selected from the group consisting of paper, plastic and the combination thereof, and a pattern layer disposed on the base layer. A coiling action of the self-coiling spring strip results in conversion of the insulator apparatus from a straight state to a bent state. At the bent state, the deformable decorative sheet completely covers the second surface of the deformable insulator body and the self-coiling spring strip.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is an exploded perspective view of the first preferred embodiment of an insulator apparatus for a beverage container according to this invention;

FIG. 2 is an assembled perspective view of the first preferred embodiment;

FIG. 3 is a sectional view of the first preferred embodiment taken along line III-III in FIG. 2;

FIG. 4 is a perspective view of the first preferred embodiment showing conversion of an insulator apparatus from a straight state to a bent state;

FIG. 5 is a perspective view showing the first preferred embodiment of an insulator apparatus that can be used to encircle a beverage container; and

FIG. 6 is a sectional view of the second preferred embodiment of an insulator apparatus for a beverage container according to this invention.

### DETAILED DESCRIPTION OF THE PREFERRED EMBODIMENTS

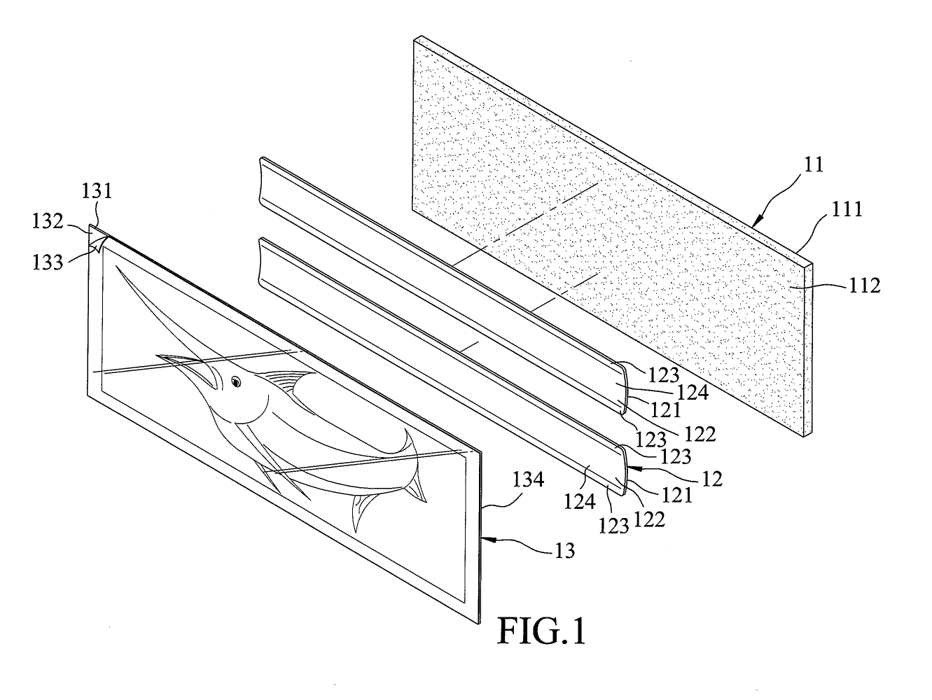

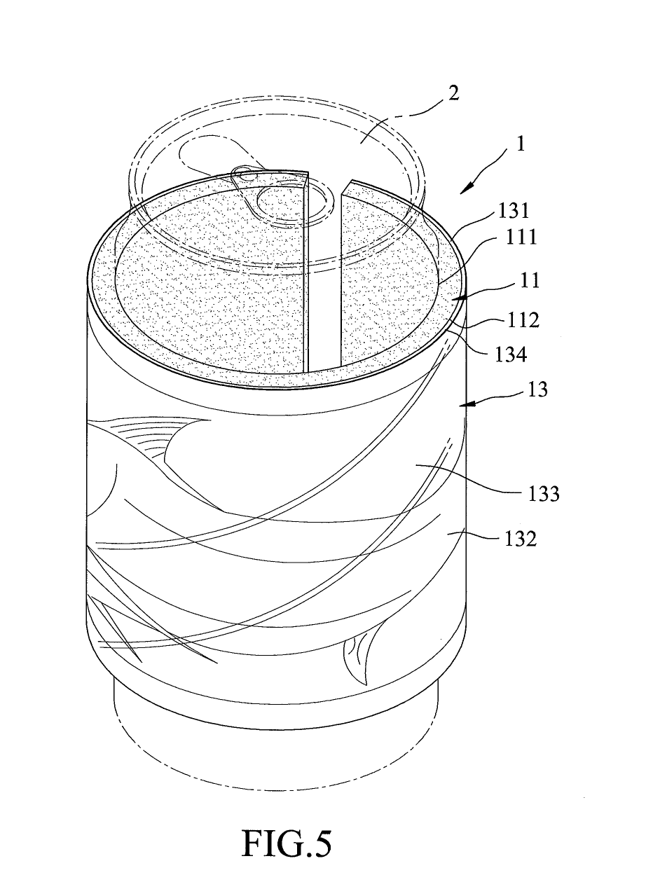

Referring to FIGS. 1 to 3, the first preferred embodiment of an insulator apparatus 1 according to the present invention includes a deformable insulator body 11, two self-coiling spring strips 12, and a deformable decorative sheet 13. The insulator apparatus 1 is adapted to encircle a beverage container 2 (see FIG. 5).

The deformable insulator body 11 is made of a foam material, and has a first surface 111 adapted to contact an outer surface of the beverage container 2, and a second surface 112 opposite to the first surface 111. In this embodiment, the deformable insulator body 11 is substantially configured to have a rectangular shape.

The self-coiling spring strips 12 are secured to the deformable insulator body 11, and are disposed parallel to each other along a longitudinal direction of the deformable insulator body 11. In this embodiment, the self-coiling spring strips 12 are secured to the second surface 112 of the deformable insulator body 11 using thermal welding. It should be noted that the self-coiling spring strips 12 may be embedded instead in the deformable insulator body 11 based on actual requirements. Each of the self-coiling spring strips 12 has an inner surface 121 that is in contact with the second surface 112, an outer surface 122 that is opposite to the inner surface 121, two adhesive regions 123 that are respectively disposed at longitudinal ends of each of the self-coiling spring strips 12, and a deformable region 124 that is disposed between the adhesive regions 123.

The deformable decorative sheet 13 is disposed on the second surface 112 of the deformable insulator body 11, and has a base layer 131 and a pattern layer 132 disposed on the base layer 131. The base layer 131 is made of a material selected from the group consisting of paper, plastic and the combination thereof. The plastic for the base layer 131 can be commercially available from Deep Crystal, Krystex, or Vynex companies. The pattern layer 132 provides a printing pattern of, for example, pictures, trademarks, logo, and characters. In this embodiment, the base layer 131 is disposed between the second surface 112 of the deformable insulator body 11 and the pattern layer 132.

Preferably, the deformable decorative sheet 13 further includes a transparent protective layer 133 that is used to protect the pattern layer 132, that is disposed on the pattern layer 132 oppositely of the base layer 131, and that is made of plastic. The plastic can be commercially available from Deep Crystal, Krystex, or Vynex companies. In this embodiment, the transparent protective layer 133 is a pearl film that provides a soft visual appearance and fingerprint-resistant effect.

However, it should be noted that the transparent protective layer 133 can be omitted based on actual requirements. In such case, preferably, the base layer 131 should be made of plastic.

Preferably, the deformable decorative sheet 13 further includes an adhesive layer 134 disposed between the base layer 131 and the deformable insulator body 11 so as to connect the base layer 131 to the deformable insulator body 11 and the self-coiling spring strips 12. Examples of the adhesive layer 134 include cold adhesive, heat reactive adhesive, and cement that are commercially available from DAP, Weldwood company, etc. In this embodiment, the adhesive layer 134 is formed between the base layer 131 and the deformable insulator body 11 and between the base layer 131 and the adhesive regions 123 of each of the self-coiling spring strips 12. That is to say, there is no adhesive layer between the base layer 131 and the deformable region 124 of each of the self-coiling spring strips 12.

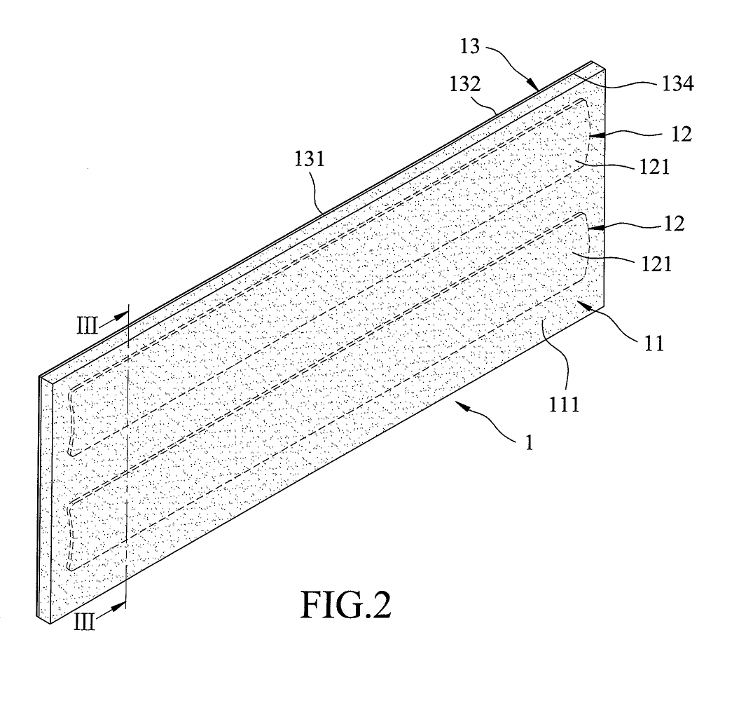

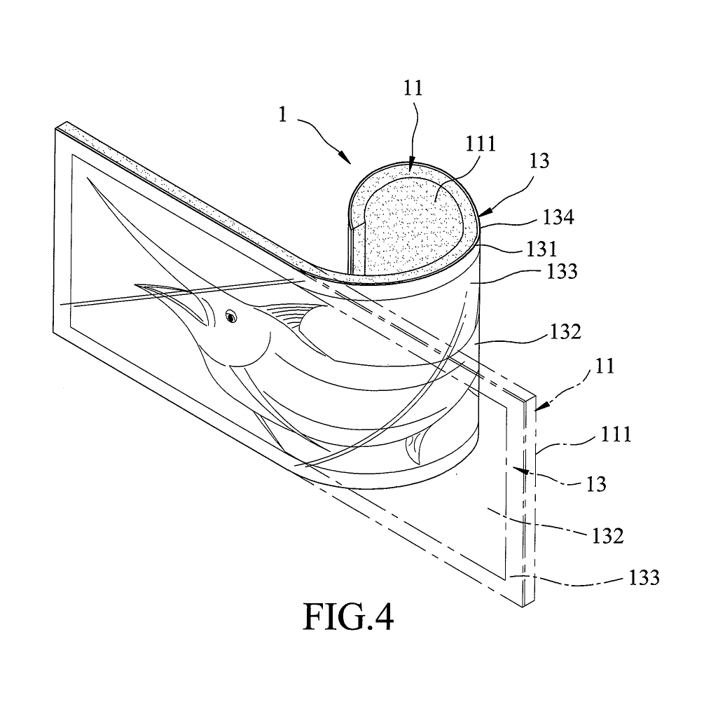

Referring to FIGS. 2, 4 and 5, when the self-coiling spring strips 12 are subjected to an external force, a coiling action of the self-coiling spring strips 12 results in conversion of the insulator apparatus 1 from a straight state to a bent state.

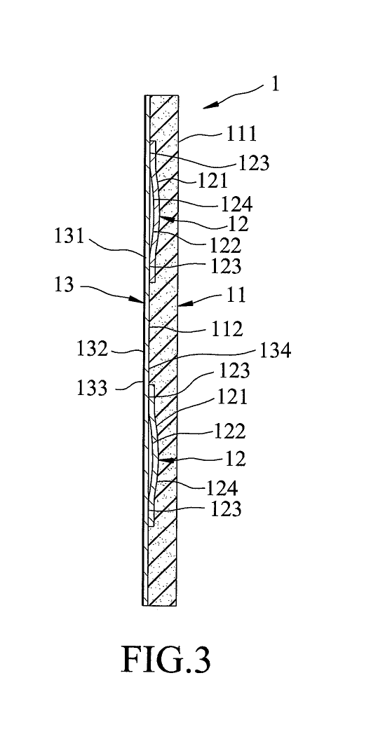

At the straight state, the self-coiling spring strips 12 are in an un-coiling state and the insulator apparatus 1 is substantially flat in shape. At this state, the deformable region 124 of each of the self-coiling springs 12 is concaved from the adhesive regions 123 toward the deformable insulator body 11 (see FIG. 3).

At the bent state, the self-coiling spring strips 12 are in a self-coiling state and in each of the self-coiling spring strips 12, the adhesive regions 123 are flush with the deformable region 124. At this state, the deformable decorative sheet 13 completely covers the second surface 112 of the deformable insulator body 11 and the self-coiling spring strips 12. That is to say, the deformable insulator body 11 and the self-coiling spring strips 12 cannot be viewed from the outside.

The beverage container 2 can be, e.g., a can or a glass. The deformable insulator body 11 provides good thermal insulation property to maintain the temperature of the beverage inside the beverage container 2 and prevent a consumer from directly contacting the hot/cold beverage container. Moreover, the deformable insulator body 11 provides relatively high friction such that the insulator apparatus 1 can be secured firmly to beverage container 2.

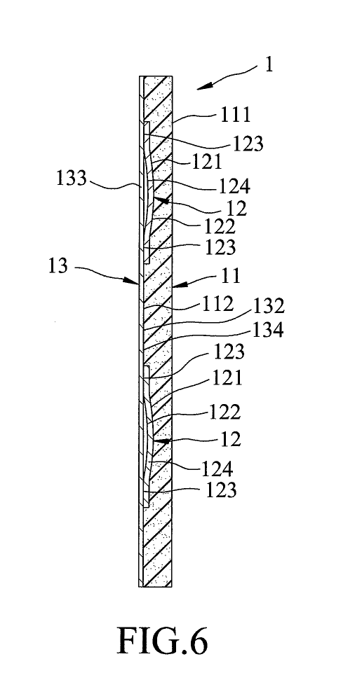

Referring to FIG. 6, the second preferred embodiment of an insulator apparatus 1 according to the present invention has a structure similar to that of the first embodiment, except that the pattern layer 132 is disposed between the second surface 112 of the deformable insulator body 11 and the base layer 131 of the deformable decorative sheet 13 and that the base layer 131 is transparent and made of plastic. In this embodiment, the base layer 131 also functions as a protective layer and thus the transparent protective layer 133 can be omitted.

In this invention, since the base layer 131 of the deformable decorative sheet 13 is made of paper or plastic, and is able to provide a relatively smooth surface, a complicated and exquisite pattern layer 132 could be accurately and precisely printed on the base layer 131. Therefore, aesthetic appearance of the insulator apparatus 1 may be improved.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. An insulator apparatus adapted to encircle a beverage container, comprising:
a deformable insulator body that is made of a foam material, and that has a first surface adapted to contact an outer surface of the beverage container, and a second surface opposite to said first surface;
a self-coiling spring strip secured to said deformable insulator body; and
a deformable decorative sheet disposed on said second surface of said deformable insulator body, and having a base layer that is made of a material selected from the group consisting of paper, plastic and the combination thereof, and a pattern layer disposed on said base layer;
wherein a coiling action of said self-coiling spring strip results in conversion of said insulator apparatus from a straight state to a bent state,
wherein, at the bent state, said deformable decorative sheet completely covers said second surface of said deformable insulator body and said self-coiling spring strip.

2. The insulator apparatus as claimed in claim 1, wherein said base layer is disposed between said second surface of said deformable insulator body and said pattern layer.

3. The insulator apparatus as claimed in claim 2, wherein said base layer is made of paper.

4. The insulator apparatus as claimed in claim 3, wherein said deformable decorative sheet further includes a transparent protective layer disposed on said pattern layer oppositely of said base layer.

5. The insulator apparatus as claimed in claim 4, wherein said transparent protective layer is made of plastic.

6. The insulator apparatus as claimed in claim 2, wherein said base layer is made of plastic.

7. The insulator apparatus as claimed in claim 6, wherein said deformable decorative sheet further includes a transparent protective layer disposed on said pattern layer oppositely of said base layer.

8. The insulator apparatus as claimed in claim 7, wherein said transparent protective layer is made of plastic.

9. The insulator apparatus as claimed in claim 2, wherein said deformable decorative sheet further includes an adhesive layer disposed between and connecting said base layer and said deformable insulator body.

10. The insulator apparatus as claimed in claim 1, wherein
said pattern layer is disposed between said second surface of said deformable insulator body and said base layer of said deformable decorative sheet; and
said base layer is transparent and is made of plastic.

11. The insulator apparatus as claimed in claim 1, comprising a plurality of said self-coiling spring strips that are disposed parallel to each other.
